(19) United States
(12) Patent Application Publication
(10) Pub. No.: US 2024/0403626 A1
(43) Pub. Date: Dec. 5, 2024

(54) CENTRALIZED ARCHITECTURE FOR DISTRIBUTED DATA PARALLEL TRAINING

(71) Applicant: GM Cruise Holdings LLC, San Francisco, CA (US)

(72) Inventors: Aleksandr Sidorov, Mountain View, CA (US); Igor Tsvetkov, Seattle, WA (US); Vladislav Belous, Seattle, WA (US); Ian Ackerman, San Francisco, CA (US)

(21) Appl. No.: 18/325,478

(22) Filed: May 30, 2023

(51) Int. Cl. G06N 3/08; G06N 3/045

(52) U.S. Cl. CPC G06N 3/08; G06N 3/045; B60W 60/001

(57) ABSTRACT

Systems and techniques are provided for a centralized architecture for distributed data parallel training. An example method can determine, by a centralized process in a distributed data parallel training environment used to train a model via data parallelism, a respective state of each training worker process from a plurality of training worker processes in the distributed data parallel training environment, the model comprising an artificial intelligence (AI) or machine learning (ML) model; determining, by the centralized process based on the respective state of each training worker process, a respective task that one or more training worker processes should perform with respect to a local replica of the model and/or training data associated with the local replica; and sending, by the centralized process to the one or more training worker processes, an instruction to perform the respective task with respect to the local replica of the model and/or the training data.

### CROSS-REFERENCE TO RELATED APPLICATIONS

This application is related to, and claims the benefit of priority of, U.S. Provisional Application No. 63/492,964, filed Mar. 29, 2023, entitled “CENTRALIZED DISTRIBUTED TRAINING DATA-PARALLEL ARCHITECTURE”, the contents of which are hereby incorporated by reference in their entirety and for all purposes.

### TECHNICAL FIELD

The present disclosure generally relates to distributed data parallel training of artificial intelligence (AI) and machine learning (ML) frameworks. For example, aspects of the present disclosure relate to techniques and systems for a centralized architecture for distributed data parallel training.

### BACKGROUND

AI/ML frameworks are increasingly used to perform complicated tasks with a high degree of accuracy. For example, AI/ML frameworks are often used for computer vision tasks, natural language processing, classification tasks, prediction tasks, and automation tasks (e.g., autonomous driving, etc.), among other tasks and/or applications. Moreover, the AI/ML frameworks can be integrated with other software and/or can be used with other software. For example, an AI/ML framework can be integrated and/or used with software used by an autonomous vehicle (AV) to perform autonomous driving operations, such as a perception stack of the AV, a prediction stack of the AV, a planning stack of the AV, a control stack of the AV, and/or a software system(s) of the AV (e.g., a cruise control system, a parking assistance system, a lane keeping system, a navigation system, a sensor processing and/or sensor fusion system, a collision and/or obstacle avoidance system, a path planning system, an autopilot system, a lane centering system, an electronic stability system, and/or any other system).

In many cases, an AI/ML framework can be resource and compute intensive, which can impact the costs of implementing the AI/ML framework. Moreover, training an AI/ML framework can be very difficult and costly. For example, the amount of data used to train an AI/ML framework to achieve a certain accuracy and/or performance can be very large. Such amount of training data can be difficult to obtain and/or generate. The process of generating and/or obtaining training data can be expensive and, in many cases, may involve a large number of resources. The training process can also be expensive, as it often uses a large number of resources and can involve a large number of training and/or data processing operations. Thus, the overall training of an AI/ML framework can be expensive, inefficient, and difficult to manage, implement, and/or complete.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, according to some examples of the present disclosure;

FIG. 2 is a diagram illustrating an example of a centralized distributed data parallel training system, according to some examples of the present disclosure;

FIG. 3 is a diagram illustrating an example of a transitional distributed data parallel training architecture that can be implemented before shifting to a centralized distributed data parallel training system, according to some examples of the present disclosure;

FIG. 4 illustrates an example configuration of a neural network, according to some examples of the present disclosure;

FIG. 5 is a flowchart illustrating an example process for implementing a centralized distributed data parallel training system to train an artificial intelligence or machine learning model, according to some examples of the present disclosure; and

FIG. 6 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, artificial intelligence (AI) and machine learning (ML) frameworks are increasingly used to perform a variety of tasks and can often provide a high degree of accuracy. For example, AI/ML frameworks are often used for computer vision, natural language processing, classification, prediction, and automation (e.g., autonomous driving, etc.), among other tasks and/or applications. Moreover, the AI/ML frameworks can be integrated with other software and/or can be used with other software. For example, an AI/ML framework can be integrated and/or used with software used by an autonomous vehicle (AV) to perform autonomous driving operations, such as a perception stack of the AV, a prediction stack of the AV, a planning stack of the AV, a control stack of the AV, and/or a software system(s) of the AV (e.g., a cruise control system, a parking assistance system, a lane keeping system, a navigation system, a sensor processing and/or sensor fusion system, a collision and/or obstacle avoidance system, a path planning system, an autopilot system, a lane centering system, an electronic stability system, and/or any other system).

To illustrate, AI/ML frameworks can be implemented by AVs to perform difficult, complex, and/or routine AV tasks and operations. In many cases, the AI/ML frameworks can provide a higher degree of precision than other types of software and/or algorithms. In some examples, an AI/ML framework can process data from various sensors of an AV, and use the sensor data to perform various tasks, operations, and/or computations. An AV is a motorized vehicle that can navigate without a human driver. In general, an AV can include various sensors mounted at specific locations on the AV, such as a camera sensor, a light detection and ranging (LIDAR) sensor, a radio detection and ranging (RADAR) sensor, an acoustic sensor, amongst others. The AV can use the sensors to collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. In many cases, the internal computing system can implement one or more AI/ML models used by the internal computing system of the AV to make decisions, perform tasks and/or operations, etc.

An AI/ML framework can include an AI/ML architecture, platform, software, model(s), and/or component(s). For example, an AI/ML framework can include an AI/ML development and/or training platform, an AI/ML architecture, and/or one or more AI/ML models. In many cases, an AI/ML framework can be compute and resource intensive, which can impact the cost, complexity, and/or difficulty of implementing the AI/ML framework. Moreover, training an AI/ML model can be difficult and expensive. For example, the amount of data used to train an AI/ML model in order to achieve a certain accuracy and/or performance can be large. Such amount of training data can be difficult to obtain and/or generate. The process of generating and/or obtaining training data can be time consuming, expensive and, in many cases, resource intensive. The training process can also be expensive, as it often uses a large amount of resources and typically involves numerous training and/or data processing operations. Thus, the overall training of an AI/ML model can be expensive, inefficient, and difficult to manage, implement, and/or complete.

To increase the training efficiency and/or reduce the overall time to train an AI/ML model, an AI/ML framework of the AI/ML model can implement a distributed data parallel architecture that uses distributed training with data parallelism. The distributed data parallel architecture can include a distributed training system that implements training workers across multiple nodes that host, run, and train local models, which include local instances (e.g., copies/replicas) of the AI/ML model being trained. The training workers across the multiple nodes can train the local models in parallel mode. This can increase the efficiency of the training process and reduce the overall training time (e.g., the duration of the training process) associated with the training process, which can include the amount of time used to complete the training process from a beginning of the training process (e.g., from a start state and/or a first/initial training operation and/or iteration). In some cases, the training process can complete when the AI/ML model achieves a desired accuracy, performance, and/or output, when a loss and/or error gradient associated with the AI/ML model reaches a threshold and/or is reduced to (and/or below) a target loss and/or error gradient, when the loss and/or error gradient associated with the AI/ML model is reduced by a threshold amount, when the training process completes a certain amount of training iterations, when a reduction in a loss and/or error gradient achieved at each subsequent training iteration is below a threshold, and/or when any other training criterion/criteria is/are achieved or satisfied.

The multiple nodes running the training workers and hosting the local models can include multiple hosts (e.g., physical and/or virtual devices, servers, computers, etc.), software containers, and/or processing devices. In some cases, the multiple nodes can include multiple processing devices such as, for example and without limitation, multiple graphical processing units (GPUs), central processing units (CPUs), processor cores, field-programmable gate arrays (FPGAs), integrated circuits (e.g., system-on-chips (SoCs), application-specific integrated circuits (ASICs), etc.), and/or any other processing device. The training workers can include processes configured to use respective portions of data to train the local models. For example, a training worker can include a process configured to process one or more sets of training data via a local model (e.g., a local instance of the AI/ML model) hosted by a node running the training worker. Based on the one or more sets of training data, the training worker can calculate parameter gradients and update model parameters associated with the local model. The training workers can synchronize gradients and model buffers across the distributed training system. Moreover, the local models can start from a same state and have the same gradients (e.g., the same averaged gradients) in every iteration. This way, the local models can maintain a synchronized state.

In some examples, the distributed training system can implement tensor computing and one or more deep neural networks, and the training workers can implement a distributed data parallel (DDP) process/application. The tensor computing can include or provide acceleration via processing devices, such as GPUs for example. The one or more deep neural networks can be built on a tape-based automatic differentiation system. The tape-based automatic differentiation system can include a reverse-mode automatic differentiation. For example, the tape-based automatic differentiation system can remember all operations it executed in a forward phase/pass, and replay the operations in a backward phase/pass. During the backward phase/pass, the tape-based automatic differentiation system can traverse the operations in a reverse order to compute gradients. The tape-based automatic differentiation system can use a “tape” to compute the gradients of a recorded computation using reverse mode differentiation.

The training workers in the distributed training system can make various decisions during the training process. For example, a training worker at a node (e.g., at a processing device such as a GPU, a CPU, a processor core, an ASIC, an FPGA, etc.) can determine whether to continue training the local model at the node (e.g., determine whether to perform additional training iterations) or evaluate the local model at the node for a different epoch. In some examples, the training workers can determine an overall state of the training process to make decisions such as, for example, to determine whether to perform an additional training iteration(s), process additional training data, or evaluate the local model (and/or the training data). For example, each training worker can guess or attempt to understand the global state (e.g., the overall state) of the AI/ML model associated with the distributed training system, and make its own decisions about training the local model associated with the training worker or evaluating the local model and/or the training data. In general, it can be difficult for each training worker to understand the global (e.g., overall) state of the distributed training system and/or reason about the overall training state of the distributed training system. For example, if the distributed training system encounters an error, it can be difficult for a training worker to determine the overall training state of the distributed training system and/or debug the error (e.g., make decisions pertaining to debugging the error).

In some cases, the training workers may not support advanced retries or retry strategies in failure and/or error cases/scenarios, or may struggle to implement advanced retries or retry strategies in failure and/or error cases/scenarios. The training workers (and/or the distributed training system) may not detect timeouts (and/or may have difficulty detecting timeouts) experienced during the training process, and may have difficulty (or may not support) recovering from certain conditions. For example, when a training worker is stuck (e.g., experiences a timeout, a failure, and/or an inability to continue a task/operation), the training worker may not be unable to recover its stuck state (or may have difficulty recovering from its stuck state). Thus, the distributed training system (and/or the associated training workers) may be unable to recover from training worker stuckness (or may have difficulty recovering from training worker stuckness).

Systems, apparatuses, processes (also referred to as methods), and computer-readable media (collectively referred to as “systems and techniques”) are described herein for improved distributed data parallel (DDP) training. In some examples, the systems and techniques described herein can provide and/or implement a centralized DDP training architecture for improved data parallelism, training efficiency, debugging, retry strategies, failure and/or error recovery, state management, and/or decision-making, among other benefits. The centralized DDP training architecture can include a centralized process that can send tasks to training workers, such as a task to process a set of data (e.g., a mini-batch input) or switch to an evaluation for a different epoch (e.g., switch to evaluation of a dataset); save (e.g., store, record, persist, maintain, etc.) checkpoints and/or state information (e.g., local and/or global state, iteration counts, metrics, etc.); handle failures and/or recover from errors; detect timeouts; recover training workers from stuck states; implement advanced retries or retry strategies; perform debugging; communicate with external nodes/entities (e.g., external relative to the training workers, the nodes running the training workers, and/or the centralized DDP training architecture); etc.

In some examples, the centralized process can include or represent a primary process responsible for making decisions about what should happen next (e.g., what task should be performed, etc.) and holding (and/or maintaining) the state of the training workers (and/or the centralized DDP training architecture including the training workers and associated nodes). The centralized process can communicate instructions to the training workers about what task and/or action that training workers should perform (e.g., what the training workers should do next). Moreover, the centralized process can recover the state of any training worker(s) as needed. In some cases, the training workers can have (or may only need) a certain understanding (e.g., a minimal understanding) of the overall state of the AI/ML model, the training workers, and/or the centralized DDP training architecture. The training workers can focus on (and/or can focus solely on) their assigned tasks.

The centralized process can be and/or represent the source of truth about the training process. Thus, in some cases, any or all external communications (e.g., communications with nodes, devices, entities, networks, etc., external to the training workers, the nodes running the training workers, and/or the centralized DDP training architecture) can be relayed through the centralized process. In certain situations, training workers may be permitted to directly communicate with certain network endpoints. For example, the training workers may be permitted to directly communicate with one or more network endpoints during data exports (and/or large data exports), without otherwise relaying such communications through the centralized process. In some examples, data for outside visibility (e.g., to external destinations/recipients), such as metadata and/or pointers to data for outside visibility, may go through the centralized process (e.g., may be relayed or communicated through the centralized process).

The centralized process can be configured to expect and/or require training workers to complete instructions (e.g., instructions from the centralized process) within a certain period of time (e.g., within a threshold period of time). In some cases, the period of time can be shorter than the overall amount of time of training process (e.g., the duration of the training process). This can simplify timeout management, which typically adds complexity to training systems.

As illustrated above, unlike decentralized approaches where training workers attempt to determine or guess each other's states, the centralized DDP training architecture can maintain the states of training workers at a centralized location and/or entity (e.g., the centralized process). Some DDP training architectures may implement libraries that provide a managed training loop solution and are not suitable (e.g., are not well suited for and/or do not support) a centralized training approach or architecture, such as the centralized DDP training architecture described herein. In such cases, the systems and techniques described herein can adapt the architecture to support a centralized training approach and/or architecture, or can implement a transitional approach without adapting the architecture (or with minimal or reduced adaptation of the architecture).

In the transitional approach, the distributed training state of the training workers can be stored in and/or maintained by a state manager. The state manager can include an entity configured to store and/or maintain state information, such as a node, a process/application, a server, etc. The state manager can obtain the state of the training workers through a push and/or pull scheme. For example, the training workers can write their state to the state manager, which can maintain the state information from the training workers. The centralized process can access (e.g., read, retrieve, etc.) state information from the state manger. For example, the centralized process can retrieve the state of training workers from the state manager. The transitional approach can include or represent a migration model, where state information is maintained by the state manager as the decision-making process is shifted or is gradually shifted from the training workers to the centralized process. In some cases, the decision-making process can be gradually shifted from the training workers to the centralized process layer-by-layer. With this approach, the systems and techniques described herein can quickly achieve centralized state management and smoothly or seamlessly transition towards centralized decision-making without disruption or with minimal disruption.

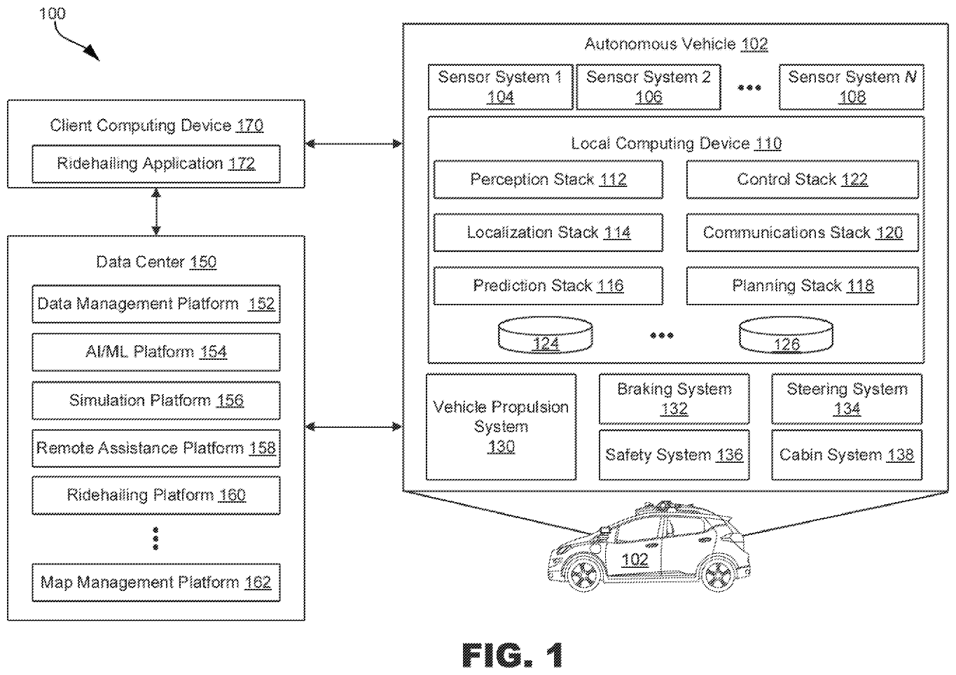

Examples of the systems and techniques described herein for processing data are illustrated in FIG. 1 through FIG. 6 and described below.

In some cases, the centralized DDP training architecture can be used to train AI/ML models/software of an autonomous vehicle and/or an autonomous vehicle management system. FIG. 1 illustrates an example autonomous vehicle (AV) management system 100 according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the client application 172 to enable passengers to view the AV 102 in transit to a pick-up or drop-off location, and so on.

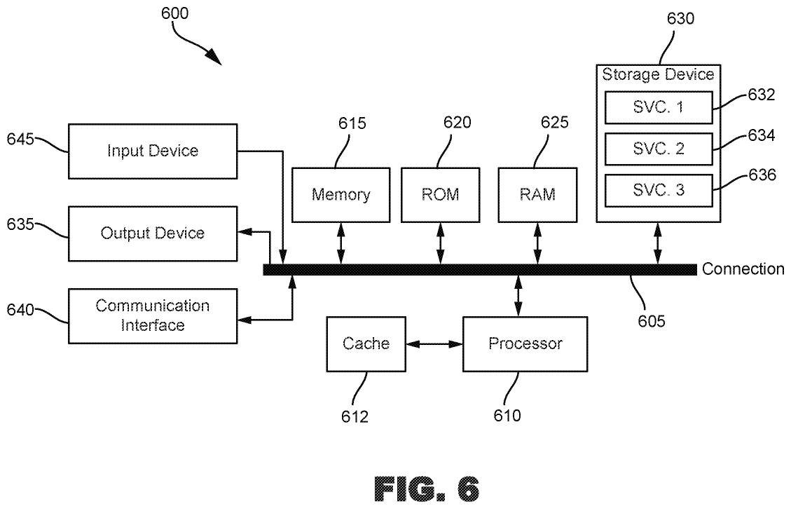

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

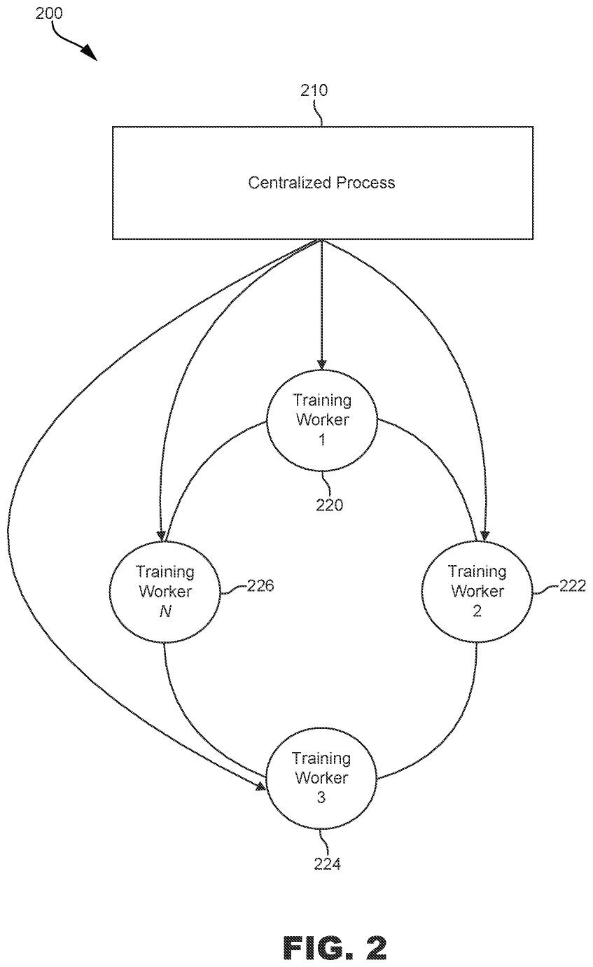

FIG. 2 is a diagram illustrating an example of a centralized distributed data parallel (DDP) system 200. In this example, the centralized DDP system 200 can include training workers 220-226 and a centralized process 210. The training workers 220-226 can include training processes and/or applications hosted on respective nodes. For example, the training workers 220-226 can include DDP applications and/or processes running on respective nodes hosting the training workers 220-226. Similarly, the centralized process 210 can include a centralized management process, application, trainer, master, and/or driver hosted by one or more nodes. In some examples, the training workers 220-226 and/or the centralized process 210 can implement and/or can be implemented by one or more AI/ML models. For example, each training worker can implement and/or be implemented by a deep neural network. Similarly, the centralized process 210 can implement and/or can be implemented by a deep neural network.

The nodes hosting (and running) the training workers 220-226 can include physical and/or virtual/logical nodes (e.g., hosts). For example, each of the nodes hosting the training workers 220-226 can include a host (e.g., a physical and/or virtual device, a server, a computer, etc.), a software container, and/or a processing device. Similarly, the one or more nodes hosting (and running) the centralized process 210 can include one or more hosts (e.g., one or more physical and/or virtual devices, servers, computers, etc.), software containers, and/or processing devices. The processing devices (e.g., the nodes hosting the training workers 220-226 and/or the one or more nodes hosting the centralized process 210) can include, for example and without limitation, graphical processing units (GPUs), central processing units (CPUs), processor cores, field-programmable gate arrays (FPGAs), integrated circuits (e.g., system-on-chips (SoCs), application-specific integrated circuits (ASICs), etc.), and/or any other processing devices. In some cases, a node can host multiple training workers. In other case, a node can host a single training worker (e.g., a dedicated node).

The centralized DDP system 200 can be used for distributed data parallel training of an AI/ML model(s) using a centralized entity (e.g., centralized process 210) for various tasks. Each of the training workers 220-226 can be associated with (e.g., can operate on) a local instance of the AI/ML model(s) being trained via the distributed data parallel training. For example, a node hosting a training worker can also host a local instance of the AI/ML model(s), which the training worker can train as further described herein. The local instance of the AI/ML model(s) can include a local copy and/or replica of the AI/ML model(s). The training workers 220-226 can be configured to use respective portions of data to train the local models. For example, each training worker can include a process configured to process one or more sets of training data via a local model (e.g., a local instance of the AI/ML model) hosted by a node running the training worker, in order to train the local model. Based on the one or more sets of training data, the training worker can calculate parameter gradients and update model parameters associated with the local model. The training workers 220-226 can synchronize gradients and model buffers across the centralized DDP system 200. The local models (e.g., the local instances of the AI/ML model(s) trained by the training workers 220-226) can start from a same state and have the same gradients (e.g., the same averaged gradients) in every iteration. This way, the local models can maintain a synchronized state.

The tasks performed by the centralized process 210 in the centralized DDP system 200 can include, for example and without limitation, centralized decision making, sending tasks to training workers 220-226 (e.g., sending a task to process a set of data (e.g., a mini-batch input), sending a task to switch to an evaluation of a dataset and/or local model, etc.) of the centralized DDP system 200, saving (e.g., storing, recording, persisting, maintaining, etc.) checkpoints and/or state information (e.g., local and/or global state, iteration counts, metrics, etc.), handling failures and/or recovering from errors; detecting timeouts, recovering training workers 220-226 from stuck states, implementing advanced retries or retry strategies, debugging, communicating with external nodes/entities (e.g., external relative to the training workers, the nodes running the training workers, and/or the centralized DDP system 200), etc. In some examples, the state information saved, managed, tracked, maintained, exchanged/communicated and/or monitored by the centralized process 210 can include a global state (e.g., a global training state, a global parameter state, a global AI/ML model state, a global state of one or more tasks, etc.) associated with the centralized DDP system 200, local states associated with the training workers 220-226 (e.g., local states of local models associated with the training workers 220-226, local operating states of the training workers 220-226 and/or the local models, etc.), parameters (e.g., gradients, buffers, model parameters, etc.) associated with the local models trained by the training workers 220-226, training iteration counts associated with the training workers 220-226 (e.g., counts of training iterations performed by the training workers 220-226 to train the local models), metrics (e.g., training metrics, data metrics, performance metrics, model metrics, process metrics, task metrics, etc.), and/or other state information.

In some aspects, the training workers 220-226 can process different batch splits (e.g., batches of data) and calculate respective gradients based on the processing of the different batch splits. The centralized process 210 can accumulate the gradients to perform gradient descend. For example, a given input can be split across the training workers 220-226 by chunking in the batch dimension. In a forward pass, the AI/ML model is replicated on each node of each training worker, and each replica (e.g., each local model) can handle a portion of the batch. During a backward pass, gradients from each replica (e.g., from each local model) can be summed to produce an overall gradient. The overall gradient can be applied to the AI/ML model (e.g., by the centralized process 210 and/or any of the training workers 220-226) in order to update one or more parameters (e.g., weights, etc.) of the AI/ML model. In a next iteration, the updated AI/ML model can again be replicated on each node of each training worker, and each replica can handle a portion of a batch of data.

In some aspects, each training worker in the centralized DDP system 200 can run a forward and backward pass on a batch of data using a local copy of the AI/ML model (e.g., a local model). The training workers 220-226 can send the gradients calculated during the backward pass to the centralized process 210, which can run a reduce operation to compute averaged gradients. The centralized process 210 can send the averaged gradients back to the training workers 220-226, which update the model parameters. In some examples, the training workers 220-226 can update the model parameters using stochastic gradient descent (SGD). In some cases, the centralized DDP system 200 can achieve an almost linear reduction in training time using data parallelism and efficient network communications.

In some examples, the centralized DDP system 200 can implement tensor computing and one or more deep neural networks, and the training workers 220-226 can implement a DDP process/application. The tensor computing can include or provide acceleration via processing devices, such as GPUs for example. The one or more deep neural networks can be built on a tape-based automatic differentiation system. The tape-based automatic differentiation system can include a reverse-mode automatic differentiation. For example, the tape-based automatic differentiation system can remember all operations it executed in a forward phase/pass, and replay the operations in a backward phase/pass. During the backward phase/pass, the tape-based automatic differentiation system can traverse the operations in a reverse order to compute gradients. The tape-based automatic differentiation system can use a “tape” to compute the gradients of a recorded computation using reverse mode differentiation.

In some examples, the training workers 220-226 can exchange gradients generated based on training data processed by the local models associated with the training workers 220-226. The centralized process 210 can provide centralized state management, decision making, and/or orchestration of tasks. For example, as previously explained, the centralized process 210 can send tasks to the training workers 220-226, such as tasks to process a set of data (e.g., a mini-batch input), tasks to switch to an evaluation task in a different epoch (e.g., evaluation of the training data and/or the local models, etc.), save (e.g., store, record, persist, maintain, etc.) checkpoints and/or state information (e.g., local and/or global state, iteration counts, metrics, etc.), handle failures and/or recover from errors, detect timeouts, recover the training workers 220-226 from stuck states, implement advanced retries or retry strategies, debug issues, communicate with external nodes/entities (e.g., external relative to the training workers 220-226, the nodes running the training workers 220-226, and/or the centralized DDP system 200), etc.

The number of training workers 220-226 in FIG. 2 is merely an illustrative example provided for explanation purposes. One of ordinary skill in the art will recognize based on the present disclosure that, in other examples, the centralized DDP system 200 can include more or less training workers than shown in FIG. 2. Moreover, the centralized process 210 can represent a single process or a set of processes configured to perform the functionalities of the centralized process 210. Further, the centralized process 210 can be hosted by, run on, and/or executed by a single node (e.g., a single server, processing device, virtual machine, software container, computer, etc.) or multiple nodes. For example, in some cases, the centralized process 210 can include a distributed process running on multiple nodes or multiple instances of a centralized process running on multiple nodes.

Some DDP training architectures may implement libraries that provide a managed training loop solution and/or are not suitable (e.g., are not well suited for and/or do not support) a centralized training approach or architecture, such as the approach and/or architecture of the centralized DDP system 200. In such cases, the systems and techniques described herein can adapt the architecture to support a centralized training approach and/or architecture, or can implement a transitional approach. For example, in an example transitional approach, the distributed training state of the training workers 220-226 can be stored in and/or maintained by a state manager.

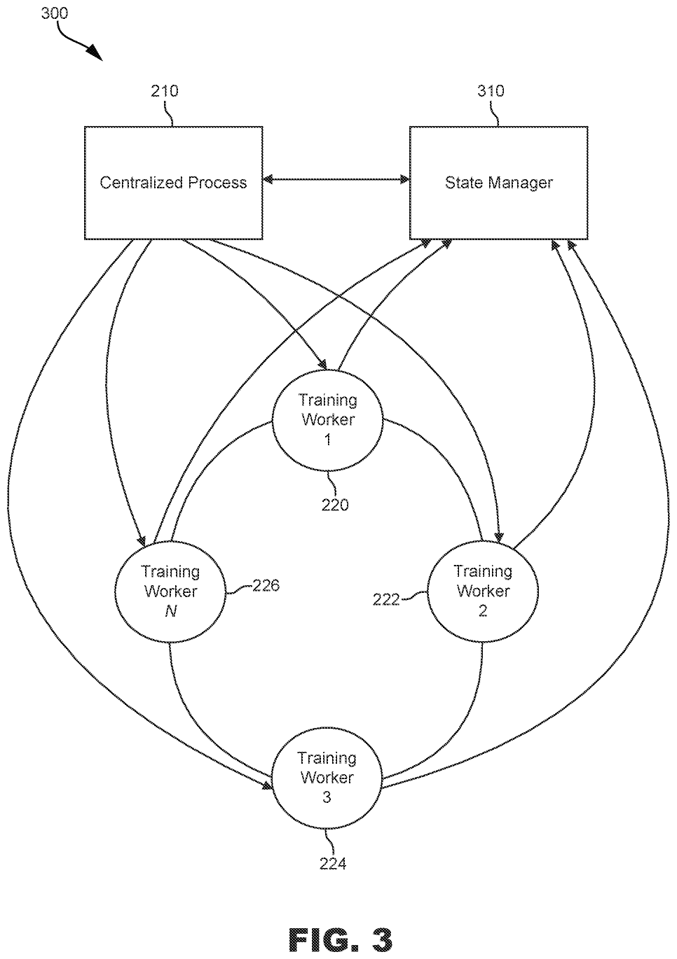

FIG. 3 is a diagram illustrating an example of a transitional DDP training architecture 300 that can be implemented before shifting (e.g., before migrating to) to the centralized DDP system 200 illustrated in FIG. 2. The transitional DDP training architecture 300 can implement a state manager 310 used to store and/or maintain the training state of the training workers 220-226.

The state manager 310 can include any entity configured to store and/or maintain state information, such as a node, a process/application, a server, etc. For example, the state manager 310 can include one or more servers, software containers, virtual machines, processing devices (e.g., one or more GPUs, CPUs, ASICs, FPGAs, SoCs, etc.), datacenters, and/or one or more computing devices, nodes, and/or entities. In some cases, the state manager 310 can implement and/or be implemented by a process configured to manage state and communicate state information to other entities in the transitional DDP training architecture 300, as further described herein.

The state manager 310 can obtain state information from the training workers 220-226 through a push and/or pull scheme. For example, the training workers 220-226 can send their state to the state manager 310 and/or write their state to the state manager 310. The state manager 310 can maintain the state information from the training workers 220-226, and provide any of the state information to the centralized process 210 and/or the training workers 220-226, as needed. In other examples, the state manager 310 can request (e.g., pull) state information from the training workers 220-226, and receive the state information from the training workers 220-226 as requested. For example, the state manager 310 can send or broadcast a pull request(s) to the training workers 220-226, and the training workers 220-226 can provide their states to the state manager 310 in response to the pull request(s). The state manager 310 can obtain state information from the training workers 220-226 on-demand (e.g., dynamically as needed), on a schedule (e.g., at one or more predetermined periods of time), in response to an event(s), based on a condition(s), and/or in response to a trigger(s).

For example, the state manager 310 can obtain state information from the training workers 220-226 in response to a request (e.g., a pull request, a push request, a save request, etc.), a completion of a training iteration, a start of a training iteration, a model update, a gradient calculation and/or update, a loss calculation, a timeout, an error, an instruction, a completion of a task by the training workers 220-226, a start of a task by the training workers 220-226, a message from the centralized process 210 to the training workers 220-226, an instruction to the training workers 220-226 (e.g., from the centralized process 210) to perform a task, an information exchange (e.g., an exchange of gradients, parameters, etc.), a state change, a checkpoint, a save instruction, a decision, a retry, a state change, a batch processing operation, a validation, a callback, a loop, a notification, a synchronization trigger, a threshold, a rule, an update, a particular state, a timer, and/or any other event, condition, and/or trigger.

The state manager 310 can store and/or maintain state information, such as local state (e.g., local states of the training workers 220-226, local states of the local models of the training workers 220-226, training states of the local models of the training workers 220-226, etc.), global state (e.g., a global state of the training workers 220-226, a global state of the AI/ML model being trained, a global state of the transitional DDP training architecture 300, a global parameter state, a global state of one or more tasks and/or operations, etc.), training iteration counts, training and/or model metrics, etc. In some examples, the state information stored and/or maintained by the state manager 310 can additionally or alternatively include parameters (e.g., gradients, buffers, model parameters, etc.) associated with the local models trained by the training workers 220-226, metrics (e.g., training metrics, data metrics, performance metrics, model metrics, process metrics, task metrics, etc.), and/or other state information.

The centralized process 210 can receive and/or access (e.g., read, retrieve, etc.) state information from the state manger 310 on-demand/dynamically (e.g., as needed), at one or more predetermined periods of time, in response to one or more events, in response to one or more triggers, as requested, at any other time, and/or in response to any other event, condition, and/or trigger. For example, the centralized process 210 can retrieve the state of the training workers 220-226 from the state manager 310 as needed or can receive the state of the training workers 220-226 from the state manager 310 as requested by the centralized process 210 and/or as it is received or processed by the state manager 310. In some cases, the training workers 220-226 can send their progress and/or updates to the state manager 310, and the centralized process 210 can monitor the state manager 310.

The centralized process 210 can use state information obtained from the state manager 310 to determine when (and/or whether) to initiate the training workers 220-226, send tasks to the training workers 220-226, monitor progress of the training (and/or the training workers 220-226), save and/or manage checkpoints, perform and/or enable fault tolerance, implement or perform advanced retries, detect and/or manage timeouts, instruct the training workers 220-226 to process data (e.g., a mini-batch input) using the local models, instruct the training workers 220-226 to switch from processing data using the local models to evaluate training data and/or local models, handle failures, recover from errors or failures, recover the training workers 220-226 from stuck states, communicate with external nodes/entities (e.g., external relative to the training workers 220-226, the nodes running the training workers 220-226, and/or the centralized DDP system 200), etc.

The use of the centralized process 210 and the state manager 310 can ensure that training state information is maintained in a centralized location, simplify timeouts and/or timeout recoveries, implement advanced retry logic at a centralized location (e.g., the centralized process 210), and/or provide a gradual path, shift, and/or migration from a decentralized architecture to the centralized DDP system 200 illustrated in FIG. 2.

As previously explained, some DDP training architectures may implement libraries that provide a managed training loop solution and/or may not be suitable (e.g., may not be well suited for and/or support) a centralized training approach or architecture, such as the approach and/or architecture of the centralized DDP system 200 illustrated in FIG. 2. However, the transitional DDP training architecture 300 can provide a migration model where state information is maintained by the state manager 310 as the decision-making is shifted or gradually shifted from the training workers 220-226 to a centralized location (e.g., the centralized process 210). For example, the transitional DDP training architecture 300 can allow the decision-making for the DDP training to be gradually shifted on a layer-by-layer basis (e.g., one or more changes, shifts, steps, components, changes, and/or adaptations at a time) from the training workers 220-226 to the centralized process 210. In some examples, a decentralized approach for DDP training can be migrated and/or modified to implement the transitional DDP training architecture 300. The transitional DDP training architecture 300 can then be migrated and/or modified to the centralized DDP system 200 illustrated in FIG. 2. In some cases, the transitional DDP training architecture 300 can be gradually shifted (e.g., adapted, migrated, modified, re-structured/re-engineered, etc.) to the centralized DDP system 200 at once, sequentially, in multiple migration iterations, on a layer-by-layer basis, a component-by-component basis, or on any other basis.

By implementing the transitional DDP training architecture 300, the DDP training approach and/or architecture can be adapted to achieve centralized state management and centralized decision-making, and/or centralized orchestration quickly, efficiently, accurately, smoothly (e.g., with greater stability; without or with reduced/limited errors, failures, delays, setbacks, and/or issues; with greater control; without or with less unexpected results or issues; etc.), seamlessly, and effectively. For example, by implementing the transitional DDP training architecture 300, the DDP training approach and/or architecture can be quickly, smoothly, and/or seamlessly adapted to achieve centralized state management and transition towards centralized decision-making without disruption or with minimal disruption.

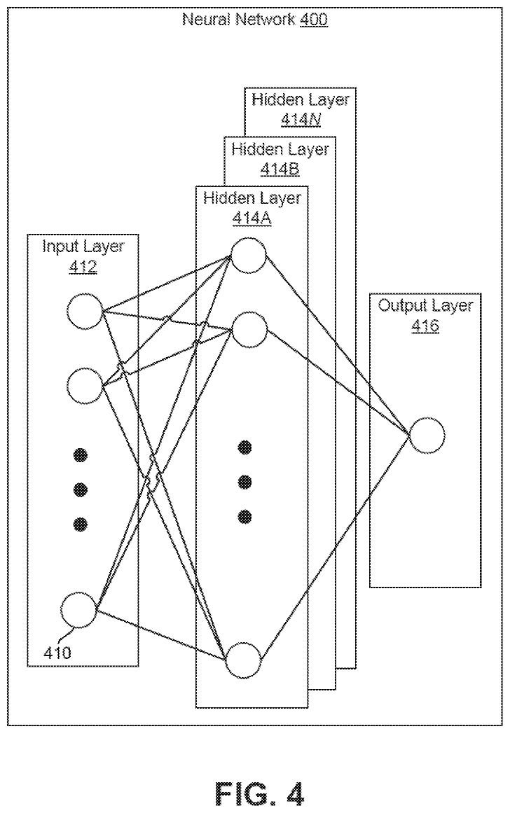

FIG. 4 illustrates an example configuration of a neural network 400 according to some examples of the present disclosure. The neural network 400 can be used to implement the centralized process 210, the state manager 310, and/or any of the training workers 220-226. In some cases, the neural network 400 can additionally or alternatively be trained using the DDP training approaches described herein, such as the centralized DDP system 200 and the transitional DDP training architecture 300. The example configuration in FIG. 4 is merely one illustrative example provided for clarity and explanation purposes. One of ordinary skill in the art will recognize that other configurations of a neural network are also possible and contemplated herein.

In FIG. 4, the neural network 400 includes an input layer 412 which includes input data. The input data can include any data such as, for example, image data, acoustic data, sensor data, tensor data, etc. The neural network 400 includes hidden layers 414A through 414N (collectively “414” hereinafter). The hidden layers 414 can include n number of hidden layers, where n is an integer greater than or equal to one. The number of hidden layers can be made to include as many layers as needed for a given application. The neural network 400 further includes an output layer 416 that provides an output resulting from the processing performed by the hidden layers 414. In one illustrative example, the output layer 416 can provide a prediction, classification, content item, a segmentation output, and/or any other type of output.

The neural network 400 can include a multi-layer deep learning network of interconnected nodes. Each node can represent a piece of information. Information associated with the nodes is shared among the different layers. In some examples, each layer can retain information as information is processed. In some cases, the neural network 400 can include a feedforward network, in which case there are no feedback connections where outputs of the network are fed back into itself. For example, the neural network 400 can implement a backpropagation algorithm for training the feedforward neural network. In some cases, the neural network 400 can include a recurrent neural network, which can have loops that allow information to be carried across nodes while reading in input.

Information can be exchanged between nodes (e.g., node 410) through node-to-node interconnections between the various layers. Nodes of the input layer 412 can activate a set of nodes in the first hidden layer 414A. For example, as shown, each of the input nodes of the input layer 412 is connected to each of the nodes of the first hidden layer 414A. The nodes of the hidden layer 414A can transform the information of each input node by applying activation functions to the information. The information derived from the transformation can be passed to and can activate the nodes of the next hidden layer (e.g., 414B), which can perform their own designated functions. Example functions include convolutional, up-sampling, data transformation, pooling, filtering, and/or any other suitable functions. The output of the hidden layer (e.g., 414B) can activate nodes of the next hidden layer (e.g., 414N), and so on. The output of the last hidden layer can activate one or more nodes of the output layer 416, at which point an output is provided. In some cases, while nodes (e.g., node 410) in the neural network 400 are shown as having multiple output lines, a node has a single output and all lines shown as being output from a node represent the same output value.

In some cases, each node or interconnection between nodes can have a weight that is a set of parameters derived from training the neural network 400. For example, an interconnection between nodes can represent a piece of information learned about the interconnected nodes. The interconnection can have a numeric weight that can be tuned (e.g., based on a training dataset), allowing the neural network 400 to be adaptive to inputs and able to learn as more data is processed.

The neural network 400 can be trained to process features from the data in the input layer 412 using the different hidden layers 414 in order to provide the output through the output layer 416. In an example in which the neural network 400 is used to determine that an acoustic signature of an input is associated with sensor contamination, the neural network 400 can be trained using acoustic signatures associated with sensor contamination.

In some cases, the neural network 400 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 400 is trained enough so that the weights of the layers are accurately tuned.

For the example of segmenting data, the forward pass can include passing a training image through the neural network 400. The weights can be initially randomized before the neural network 400 is trained. The image can include, for example, an array of numbers representing pixels of the image. Each number in the array can include a value from 0 to 255 describing the pixel intensity at that position in the array. In one example, the array can include a 24×24×3 array of numbers with 24 rows and 24 columns of pixels and 3 color components (such as red, green, and blue, or luma and two chroma components, or the like).

For a first training iteration for the neural network 400, the output can include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 400 is unable to determine low level features and thus cannot make an accurate determination of what the classification of the object might be. A loss function can be used to analyze errors in the output. Any suitable loss function definition can be used.

The loss (or error) can be higher for the first training inputs since the actual values will be different than the predicted output. The goal of training is to minimize the amount of loss so that the predicted output is the same as a ground truth or training sample. The neural network 400 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 400 can include any suitable deep network. For example, the neural network 400 can include a convolutional neural network (CNN), a U-Net, a DCT-Network, an artificial neural network, an encoder-decoder network, a generative adversarial model, an R-CNN, a fully-connected network (FCN), and/or any other deep neural network. An illustrative example of a neural network (e.g., neural network 400) can include a CNN. The CNN can include an input layer, one or more hidden layers, and an output layer, as previously described. The hidden layers of a CNN can include a series of convolutional, nonlinear, pooling (e.g., for down sampling), and fully connected layers. In other examples, the neural network 400 can represent any other deep network such as an autoencoder, a deep belief nets (DBNs), a Recurrent Neural Networks (RNNs), etc.

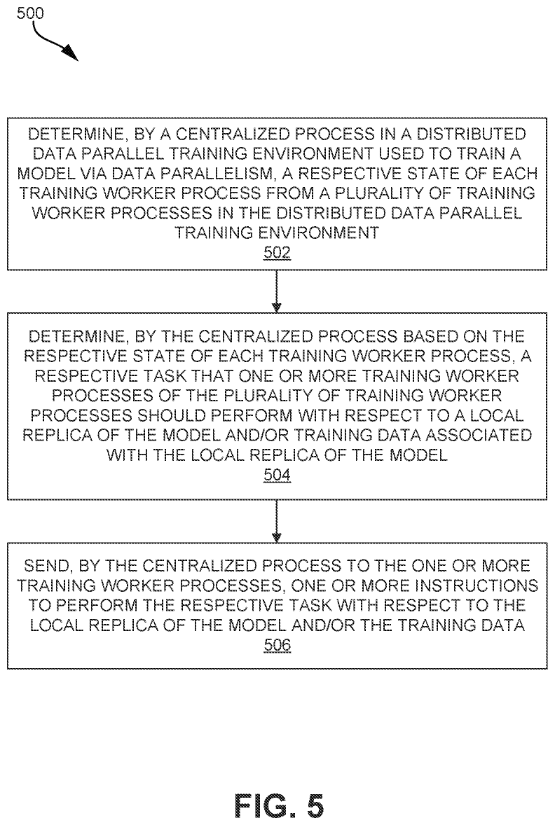

FIG. 5 is a flowchart illustrating an example process 500 for implementing a centralized DDP training system to train an AI/ML model. At block 502, the process 500 can include determining, by a centralized process (e.g., centralized process 210) in a distributed data parallel training environment used to train a model via data parallelism, a respective state of each training worker process from a plurality of training worker processes (e.g., training worker 220, training worker 222, training worker 224, training worker 226) in the distributed data parallel training environment. The model can include an artificial intelligence (AI) or machine learning (ML) model, such as a deep learning neural network.

At block 504, the process 500 can include determining, by the centralized process based on the respective state of each training worker process, a respective task that one or more training worker processes of the plurality of training worker processes should perform with respect to a local replica of the model and/or training data associated with the local replica of the model.

In some examples, the respective task can include a task to train the local replica of the model using additional training data. In response, each training worker process can train the local replica of the model using the additional training data (e.g., each training worker process can process the additional training data using the local replica of the model). In some cases, each training worker process can determine a gradient, error/loss, and/or model update(s) based on the training of the local replica of the model. In some aspects, the process 500 can include receiving, from the one or more training worker processes, an updated model parameter determined based on the training of the local replica of the model using the additional training; and updating the model based on the updated model parameter.

In other examples, the respective task can include evaluating the local replica of the model, the training data, and/or additional training data selected for additional training of the local replica of the model. For example, the respective task can include a task for each training worker process to evaluate its local replica of the model and/or training data used by the training worker process to train its local replica of the model.

In some cases, determining the respective state of each training worker process from the plurality of training worker processes can include receiving, by the centralized process, the respective state from each training worker process from the plurality of training worker processes. For example, the centralized process can request or retrieve the respective state from each training worker process. As another example, each training worker process can report or provide its respective state to the centralized process.

In other cases, determining the respective state of each training worker process from the plurality of training worker processes can include receiving, by the centralized process, the respective state from a state manager (e.g., state manager 310) configured to receive state information from the plurality of training worker processes. For example, the state manager can receive state information from the plurality of training worker processes. The centralized process can then receive or retrieve the respective state from the state manager. The state manager can be used as a transitional training scheme, such as the transitional DDP training architecture 300 illustrated in FIG. 3.

At block 506, the process 500 can include sending, by the centralized process to the one or more training worker processes, one or more instructions to perform the respective task with respect to the local replica of the model and/or the training data. For example, the centralized process can send an instruction(s) to each of the one or more training worker processes to perform a respective task. In some cases, the respective task of different training worker processes can include a same task. In other cases, the respective task of different training worker processes can include different tasks.

In some aspects, the process 500 can include determining, by the centralized process based on respective state of a first training worker process from the plurality of training worker processes, the respective task for the first training worker process; determining, by the centralized process based on respective state of a second training worker process from the plurality of training worker processes, the respective task for the second training worker process; and instructing, by the centralized process, the first training worker process to perform the respective task for the first training worker process and the second training worker process to perform the respective task for the second training worker process. For example, the centralized process can determine different tasks for different training worker processes, and instruct the different training worker processes to perform the different tasks determined. To illustrate, the centralized process can determine that a training worker process should perform another training iteration to train its local replica of the model and determine that another training worker process should evaluate its local replica of the model and/or training data used (and/or to be used) by the other training worker process to train its local replica of the model. The centralized process can instruct the training worker process to perform the other training iteration and the other training worker process to perform the evaluation task.

In some aspects, the process 500 can include identifying, by the centralized process, an error associated with a training worker process of the plurality of training worker processes based on the respective state associated with that training worker process, and identifying, by the centralized process, a solution to the error based on the respective state associated with that training worker process. In some examples, the error can include a failure, a timeout, and/or a stuck state. For example, the error can include a stuck state that includes an inability by the training worker process to complete one or more tasks. In some aspects, the solution can include one or more tasks that the training worker process can perform to correct, eliminate, and/or avoid the error. In some examples, the solution can include debugging the error and/or performing a training retry.

In some aspects, the process 500 can include saving, by the centralized process, an overall state of the model and/or an overall state of a training of the model. For example, the centralized process can track and/or maintain an overall state of the model being trained (e.g., the AI/ML model) and/or an overall state of the training process (e.g., a training state, a state of the plurality of training worker processes, a state of the distributed data parallel training environment, etc.).

FIG. 6 illustrates an example processor-based system with which some aspects of the subject technology can be implemented. For example, processor-based system 600 can be any computing device making up local computing device 110, remote computing system 190, a passenger device executing the ridesharing application 170, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising a memory; and one or more processors coupled to the memory, the one or more processors being configured to: determine, by a centralized process in a distributed data parallel training environment used to train a model via data parallelism, a respective state of each training worker process from a plurality of training worker processes in the distributed data parallel training environment, the model comprising an artificial intelligence (AI) or machine learning (ML) model; determine, by the centralized process based on the respective state of each training worker process, a respective task that one or more training worker processes of the plurality of training worker processes should perform with respect to at least one of a local replica of the model and training data associated with the local replica of the model; and send, by the centralized process to the one or more training worker processes, one or more instructions to perform the respective task with respect to at least one of the local replica of the model and the training data.

Aspect 2. The system of Aspect 1, wherein the respective task comprises training the local replica of the model using additional training data.

Aspect 3. The system of Aspect 2, wherein the one or more processors are configured to: receive, from the one or more training worker processes, an updated model parameter determined based on the training of the local replica of the model using the additional training; and update the model based on the updated model parameter.

Aspect 4. The system of any of Aspects 1 to 3, wherein the respective task comprises evaluating at least one of the local replica of the model, the training data, and additional training data selected for additional training of the local replica of the model.

Aspect 5. The system of any of Aspects 1 to 4, wherein determining the respective state of each training worker process from the plurality of training worker processes comprises receiving, by the centralized process, the respective state from each training worker process from the plurality of training worker processes.

Aspect 6. The system of any of Aspects 1 to 5, wherein determining the respective state of each training worker process from the plurality of training worker processes comprises receiving, by the centralized process, the respective state from a state manager configured to receive state information from the plurality of training worker processes.

Aspect 7. The system of any of Aspects 1 to 6, wherein the one or more processors are configured to identify, by the centralized process, an error associated with a training worker process of the plurality of training worker processes based on the respective state associated with that training worker process, and identify, by the centralized process, a solution to the error based on the respective state associated with that training worker process.

Aspect 8. The system of Aspect 7, wherein the error comprises at least one of a failure, a timeout, and a stuck state, the stuck state comprising an inability by the training worker process to complete one or more tasks.

Aspect 9. The system of any of Aspects 1 to 8, wherein the one or more processors are configured to save, by the centralized process, at least one of an overall state of the model and an overall state of a training of the model.

Aspect 10. The system of any of Aspects 1 9, wherein the one or more processors are configured to: determine, based on respective state of a first training worker process from the plurality of training worker processes, the respective task for the first training worker process; determine, based on respective state of a second training worker process from the plurality of training worker processes, the respective task for the second training worker process; and instruct, by the centralized process, the first training worker process to perform the respective task for the first training worker process and the second training worker process to perform the respective task for the second training worker process.

Aspect 11. A method comprising: determining, by a centralized process in a distributed data parallel training environment used to train a model via data parallelism, a respective state of each training worker process from a plurality of training worker processes in the distributed data parallel training environment, the model comprising an artificial intelligence (AI) or machine learning (ML) model; determining, by the centralized process based on the respective state of each training worker process, a respective task that one or more training worker processes of the plurality of training worker processes should perform with respect to at least one of a local replica of the model and training data associated with the local replica of the model; and sending, by the centralized process to the one or more training worker processes, one or more instructions to perform the respective task with respect to at least one of the local replica of the model and the training data.

Aspect 12. The method of Aspect 11, wherein the respective task comprises training the local replica of the model using additional training data.

Aspect 13. The method of Aspect 12, further comprising: receiving, from the one or more training worker processes, an updated model parameter determined based on the training of the local replica of the model using the additional training; and updating the model based on the updated model parameter.

Aspect 14. The method of any of Aspects 11 to 13, wherein the respective task comprises evaluating at least one of the local replica of the model, the training data, and additional training data selected for additional training of the local replica of the model.

Aspect 15. The method of any of Aspects 11 to 14, wherein determining the respective state of each training worker process from the plurality of training worker processes comprises receiving, by the centralized process, the respective state from each training worker process from the plurality of training worker processes.

Aspect 16. The method of any of Aspects 11 to 15, wherein determining the respective state of each training worker process from the plurality of training worker processes comprises receiving, by the centralized process, the respective state from a state manager configured to receive state information from the plurality of training worker processes.

Aspect 17. The method of any of Aspects 11 to 16, further comprising identifying, by the centralized process, an error associated with a training worker process of the plurality of training worker processes based on the respective state associated with that training worker process, and identifying, by the centralized process, a solution to the error based on the respective state associated with that training worker process, wherein the error comprises at least one of a failure, a timeout, and a stuck state, the stuck state comprising an inability by the training worker process to complete one or more tasks.

Aspect 18. The method of any of Aspects 11 to 17, further comprising saving, by the centralized process, at least one of an overall state of the model and an overall state of a training of the model.

Aspect 19. The method of any of Aspects 11 to 18, further comprising: determining, by the centralized process based on respective state of a first training worker process from the plurality of training worker processes, the respective task for the first training worker process; determining, by the centralized process based on respective state of a second training worker process from the plurality of training worker processes, the respective task for the second training worker process; and instructing, by the centralized process, the first training worker process to perform the respective task for the first training worker process and the second training worker process to perform the respective task for the second training worker process.

Aspect 20. A non-transitory computer-readable medium having stored thereon instructions which, when executed by one or more processors, cause the one or more processors to: determine, by a centralized process in a distributed data parallel training environment used to train a model via data parallelism, a respective state of each training worker process from a plurality of training worker processes in the distributed data parallel training environment, the model comprising an artificial intelligence (AI) or machine learning (ML) model; determine, by the centralized process based on the respective state of each training worker process, a respective task that one or more training worker processes of the plurality of training worker processes should perform with respect to at least one of a local replica of the model and training data associated with the local replica of the model; and send, by the centralized process to the one or more training worker processes, one or more instructions to perform the respective task with respect to at least one of the local replica of the model and the training data.

Aspect 21. A system comprising means for performing a method according to any of Aspects 11 to 19.

Aspect 22. A computer-program product comprising means for performing a method according to any of Aspects 11 to 19.

Aspect 23. A non-transitory computer-readable medium having stored thereon instructions which, when executed by one or more processors, cause the one or more processors to perform a method according to any of Aspects 11 to 19.

What is claimed is:

1. A system comprising:
a memory; and
one or more processors coupled to the memory, the one or more processors being configured to:
determine, by a centralized process in a distributed data parallel training environment used to train a model via data parallelism, a respective state of each training worker process from a plurality of training worker processes in the distributed data parallel training environment, the model comprising an artificial intelligence (AI) or machine learning (ML) model;
determine, by the centralized process based on the respective state of each training worker process, a respective task that one or more training worker processes of the plurality of training worker processes should perform with respect to at least one of a local replica of the model and training data associated with the local replica of the model; and
send, by the centralized process to the one or more training worker processes, one or more instructions to perform the respective task with respect to at least one of the local replica of the model and the training data.

2. The system of claim 1, wherein the respective task comprises training the local replica of the model using additional training data.

3. The system of claim 2, wherein the one or more processors are configured to:
receive, from the one or more training worker processes, an updated model parameter determined based on the training of the local replica of the model using the additional training; and
update the model based on the updated model parameter.

4. The system of claim 1, wherein the respective task comprises evaluating at least one of the local replica of the model, the training data, and additional training data selected for additional training of the local replica of the model.

5. The system of claim 1, wherein determining the respective state of each training worker process from the plurality of training worker processes comprises receiving, by the centralized process, the respective state from each training worker process from the plurality of training worker processes.

6. The system of claim 1, wherein determining the respective state of each training worker process from the plurality of training worker processes comprises receiving, by the centralized process, the respective state from a state manager configured to receive state information from the plurality of training worker processes.

7. The system of claim 1, wherein the one or more processors are configured to identify, by the centralized process, an error associated with a training worker process of the plurality of training worker processes based on the respective state associated with that training worker process, and identify, by the centralized process, a solution to the error based on the respective state associated with that training worker process.

8. The system of claim 7, wherein the error comprises at least one of a failure, a timeout, and a stuck state, the stuck state comprising an inability by the training worker process to complete one or more tasks.

9. The system of claim 1, wherein the one or more processors are configured to save, by the centralized process, at least one of an overall state of the model and an overall state of a training of the model.

10. The system of claim 1, wherein the one or more processors are configured to:
determine, based on respective state of a first training worker process from the plurality of training worker processes, the respective task for the first training worker process;
determine, based on respective state of a second training worker process from the plurality of training worker processes, the respective task for the second training worker process; and
instruct, by the centralized process, the first training worker process to perform the respective task for the first training worker process and the second training worker process to perform the respective task for the second training worker process.

11. A method comprising:
determining, by a centralized process in a distributed data parallel training environment used to train a model via data parallelism, a respective state of each training worker process from a plurality of training worker processes in the distributed data parallel training environment, the model comprising an artificial intelligence (AI) or machine learning (ML) model;
determining, by the centralized process based on the respective state of each training worker process, a respective task that one or more training worker processes of the plurality of training worker processes should perform with respect to at least one of a local replica of the model and training data associated with the local replica of the model; and
sending, by the centralized process to the one or more training worker processes, one or more instructions to perform the respective task with respect to at least one of the local replica of the model and the training data.

12. The method of claim 11, wherein the respective task comprises training the local replica of the model using additional training data.

13. The method of claim 12, further comprising:
receiving, from the one or more training worker processes, an updated model parameter determined based on the training of the local replica of the model using the additional training; and
updating the model based on the updated model parameter.

14. The method of claim 11, wherein the respective task comprises evaluating at least one of the local replica of the model, the training data, and additional training data selected for additional training of the local replica of the model.

15. The method of claim 11, wherein determining the respective state of each training worker process from the plurality of training worker processes comprises receiving, by the centralized process, the respective state from each training worker process from the plurality of training worker processes.

16. The method of claim 11, wherein determining the respective state of each training worker process from the plurality of training worker processes comprises receiving, by the centralized process, the respective state from a state manager configured to receive state information from the plurality of training worker processes.

17. The method of claim 11, further comprising identifying, by the centralized process, an error associated with a training worker process of the plurality of training worker processes based on the respective state associated with that training worker process, and identifying, by the centralized process, a solution to the error based on the respective state associated with that training worker process, wherein the error comprises at least one of a failure, a timeout, and a stuck state, the stuck state comprising an inability by the training worker process to complete one or more tasks.

18. The method of claim 11, further comprising saving, by the centralized process, at least one of an overall state of the model and an overall state of a training of the model.

19. The method of claim 11, further comprising:
determining, by the centralized process based on respective state of a first training worker process from the plurality of training worker processes, the respective task for the first training worker process;
determining, by the centralized process based on respective state of a second training worker process from the plurality of training worker processes, the respective task for the second training worker process; and
instructing, by the centralized process, the first training worker process to perform the respective task for the first training worker process and the second training worker process to perform the respective task for the second training worker process.

20. A non-transitory computer-readable medium having stored thereon instructions which, when executed by one or more processors, cause the one or more processors to:
determine, by a centralized process in a distributed data parallel training environment used to train a model via data parallelism, a respective state of each training worker process from a plurality of training worker processes in the distributed data parallel training environment, the model comprising an artificial intelligence (AI) or machine learning (ML) model;
determine, by the centralized process based on the respective state of each training worker process, a respective task that one or more training worker processes of the plurality of training worker processes should perform with respect to at least one of a local replica of the model and training data associated with the local replica of the model; and
send, by the centralized process to the one or more training worker processes, one or more instructions to perform the respective task with respect to at least one of the local replica of the model and the training data.
